(19) United States
(12) Patent Application Publication
(10) Pub. No.: US 2026/0077376 A1
(43) Pub. Date: Mar. 19, 2026

(54) METHOD FOR APPLYING A COATING TO AT LEAST ONE ELECTRONIC COMPONENT AND COATING ARRANGEMENT

(71) Applicant: TDK Electronics AG, München (DE)

(72) Inventors: Sanjeevani Gosavi, Deutschlandsberg (AT); Gerhard Hojas, Söding-St. Johann (AT)

(21) Appl. No.: 19/106,606

(22) PCT Filed: Aug. 2, 2023
(86) PCT No.: PCT/EP2023/071395

§ 371 Date: Feb. 25, 2025

(30) Foreign Application Priority Data
Aug. 31, 2022 (DE) 10 2022 122 013.3

(51) Int. Cl. B05C 1/02; H01C 17/06

(52) U.S. Cl. CPC B05C 1/027; H01C 17/06

(57) ABSTRACT

A method for applying a coating to at least one electronic component is described comprising the following steps:

A) Providing a coating arrangement (1) comprising a coating roller (2), wherein the coating roller (2) is rotatable around a rotation axis (R);

B) Providing a coating material (3) on the coating roller (2);

C) Providing at least one electronic component (10);

D) Moving the at least one electronic component (10) along the rotating coating roller (3) to obtain a coating (12) of at least a part of the electronic component (10).

Moreover, a coating arrangement (1) for applying a coating (12) to at least one electronic component (10) is described.

The present invention relates to a method for applying a coating to at least one electronic component, preferably to a plurality of electronic components. Furthermore, the invention relates to a coating arrangement for applying a coating to at least one electronic component, preferably to a plurality of electronic components.

The increasing demand of NTC (Negative Temperature Coefficient) temperature sensors calls for cost-effective production by reducing material and energy consumption. But high reliability requires the use of synchronized combinations of new material and production technologies.

One essential requirement for high reliability is a coating protection layer (for e.g. mechanical, climatical, thermo-mechanical, chemical, thermal, light, etc. protection) in defined geometrical dimensions (coating layer thickness, head diameter and coated length) typically using powder and resin-based coating materials.

Currently, the state-of-the-art technologies for coating of wire contacted electronic components are fluid bed, spray gun and dip coating technologies.

These technologies are resulting in high wastage of coating materials (ratio between coating material required in component and coating material lost). Furthermore, recycling of unused coating material is required resulting in accumulation of foreign materials.

Increased demand for higher accuracy with miniaturized design requirement results in yield loss using the above mentioned technologies. In addition to that, to maintain chemical and physical composition of the coating material, additional processing steps need to be foreseen to acquire constant results (continuous stirring to avoid sedimentation, degassing to remove entrapped air).

It is an object of the present disclosure to provide a method and a coating arrangement which solve the above mentioned problems.

This object is solved by the method and the coating arrangement according to the independent claims.

According to a first aspect, a method for applying a coating to at least one electronic component is described. In particular, by means of the method a coating layer is applied at least to a part of at least one electronic component, preferably of a plurality of electronic components. The method comprises the following steps:

In a first step A) a coating arrangement is provided. The coating arrangement comprises a coating roller. The coating roller is rotatable around a rotation axis. Preferably, the coating roller is rotatable in a rotation direction.

Rotation of the coating roller in a direction opposite to the rotation direction may be prevented. The coating roller may be motor driven. In particular, the coating roller may be driven by a motor of the coating arrangement. The coating roller may comprise metal. The coating roller comprises a cylindrical shape.

In a next step B), a coating material is provided. The coating material is provided on the coating roller, in particular on an outer surface of the cylindrical coating roller. The outer cylindrical surface of the coating roller may be completely wetted with coating material. The coating material is homogeneously distributed on the coating roller. No bubbles may be present in the coating material provided on the coating roller.

The coating material may be viscous. A viscosity of the coating material may be between 4000 cP and 10000 cP. The coating material may comprise a liquid part and a solid part, i.e. the coating material may comprise an emulsion. In particular, the coating material may comprise a polymer. A coating material composition of weight solids may be between 53.4% and 57.4%.

No method steps are necessary to maintain a chemical and physical composition of the coating material. This means that additional processing steps (such as continuous stirring to avoid sedimentation, degassing to remove entrapped air etc.) must not be foreseen. The coating material remains an emulsion throughout the process. Thus, a very easy method in which only a few procedural steps are required is provided.

In a next step C), at least one electronic component is provided. Preferably, a plurality of electronic components may be provided. The electronic component may comprise a NTC temperature sensor arrangement.

The at least one electronic component may be mounted on a mounting element of the coating arrangement. The mounting element may be slidable or movable.

The mounting element/the at least one electronic component, may be slidable, in particular horizontally slidable, along a longitudinal axis. The longitudinal axis may be perpendicular to the rotation axis of the coating roller.

In a next step D), the coating roller is rotated. The coating roller is rotated in the rotation direction. The coating roller is rotated such that a thickness of the coating material is generated.

The electronic component is moved. The electronic component is passed through the coating roller. In particular, the electronic component is moved along the rotating coating roller, i.e. passed along the longitudinal axis, to obtain a coating of at least a part of the electronic component. In other words, the electronic component comes into contact with the coating material arranged on the outer surface of the coating roller and is at least partially coated with coating material.

By means of the above method using roller technology a homogenous coating with well-defined dimensions is provided on at least parts of the electronic component. No additional features of machines/no additional steps in the process are needed.

Product cost can be minimized by:
a) Reduction of process related material wastage by reducing homogenization requirements (stirring, levelling, degassing);
b) Reduction of foreign material accumulation;
c) Less machine features (recycling, spraying, dip coating bath are not required inside machine);
d) Reduction of variation in the process.

Thus, a very efficient and cost-effective method is provided for creating a coating for electronic components with well-defined dimension.

According to one embodiment, in step D) the electronic component is moved along a longitudinal axis from a start position to an end position. In particular, the mounting element, onto which the at least one electronic component may be mounted, may be moved laterally from the start position to an end position. A movement of the electronic component in an opposite direction, i.e. from the end position to the start position, may, however be prevented.

The longitudinal axis may be perpendicular to the rotation axis. The at least one electronic component may be moved laterally with respect to the rotating coating roller.

Movement of the coating roller along the longitudinal axis is, however, prevented.

Moreover, in step D, the electronic component may be brought into direct contact with the coating material. The electronic component may be passed through the coating material, in particular through the coating material thickness generated due to the rotation of the coating roller. A direct mechanical contact of the electronic component with an outer surface of the coating roller may, however, be prevented.

A direction of a viscous force of the coating material may be opposite to the direction into which the electronic component is moved in step D), in particular opposite to the moving direction along the longitudinal axis. Consequently, in this step, the viscous coating material may be wound onto a part of the electronic component to establish the coating of the electronic components. Thus, a very easy, efficient and stable method for providing the coating is disclosed.

According to one embodiment, in step D), a defined length of the electronic component is immersed through the coating material rolled continuously on the coating roller. Thus, a coating with well-defined geometrical dimensions can be provided.

According to one embodiment, a plurality of electronic components are coated by means of the method. The respective electronic component comprises a sensor head. The sensor head may comprise an upper part of the electronic component including the coating. The sensor head comprises a diameter. In this context, the diameter of the sensor head denotes an extension of the sensor head perpendicular to a main longitudinal axis of the sensor head. The diameter of the sensor head may be small. In particular, the diameter may be smaller than the diameter of a sensor head of an electronic component which has a coating achieved by standard coating processes, e.g. dip coating.

In addition to that, a variation in the diameter of the sensor head of the electronic components coated by the above method may be small. In particular, the variation may be smaller as the variation of the diameter of the sensor head of electronic components coated by conventional coating technology. In other words, the above described method is very stable and produces coatings of well-defined dimension. According to a further aspect, a coating arrangement for applying a coating to at least one electronic component, preferably to a plurality of electronic components, is described. Preferably, the coating arrangement corresponds to the coating arrangement used in the method described above. Thus, all features described in connection with the method apply also for this aspect and vice versa.

The coating arrangement comprises a coating roller. The coating roller may comprise a cylinder. The coating roller may comprise a smooth outer surface. The coating roller is rotatable around a rotation axis. The coating roller is rotatable in a rotation direction, e.g. in anti-clockwise direction. A rotation in a direction opposite to the rotation direction may be prevented. In other words, the coating roller may be rotatable only in one direction. The coating roller is rotated for coating the at least one electronic component with a coating material.

The coating roller may be adapted and arranged to be wetted with a coating material. In particular, the outer surface of the coating roller may be covered, preferably completely covered, with coating material. The coating material may be homogeneously distributed on the coating roller. In particular, no bubbles may be present in the coating material provided on the coating roller.

The coating material may be viscous. A viscosity of the coating material may be between 4000 cP and 10000 cP.

Preferably, the coating material comprises a polymer. A coating material composition of weight solids may be between 53.4% and 57.4%.

By means of the coating arrangement a homogenous coating with well-defined dimensions can be applied onto at least a part of the electronic component. At the same time, the arrangement is very simple in design, as no additional functionalities are required, for example for homogenization and/or a further mixing of the coating material. Thus, a simple, reliable and cost-effective arrangement is provided. According to one embodiment, the coating arrangement comprises a mounting element. The mounting element may be adapted and arranged for holding the at least one electronic component, preferably a plurality of electronic components. The mounting element may be moveable. In particular, the he mounting element may be moveable horizontally (laterally).

The mounting element may be vertically fixed. The mounting element and thus, the electronic component, may be moveable along a longitudinal axis. The longitudinal axis may be perpendicular to the rotation axis of the coating roller.

By horizontally moving the electronic component with respect to the rotating coating roller, viscous coating material can be effectively and homogenously distributed onto a part of the electronic component.

Further features, refinements and expediencies become apparent from the following description of the exemplary embodiments in connection with the figures.

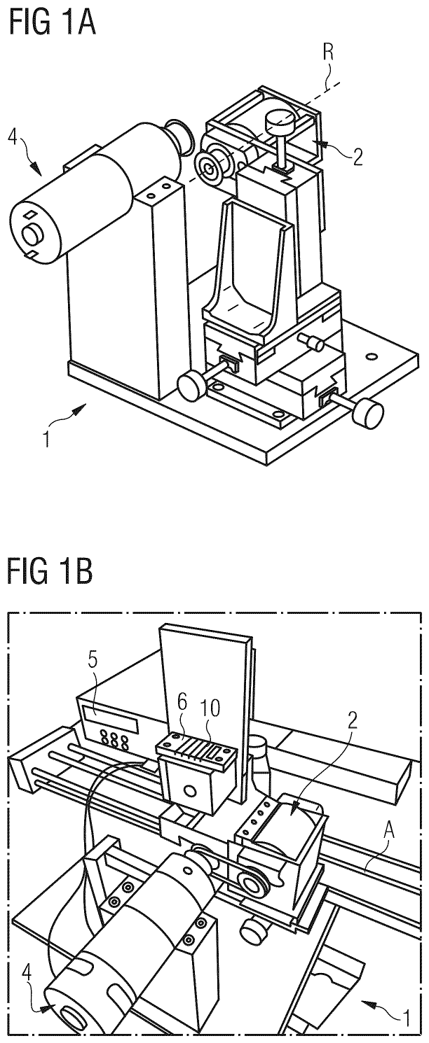

FIGS. 1a and 1b show perspective views of a coating arrangement,

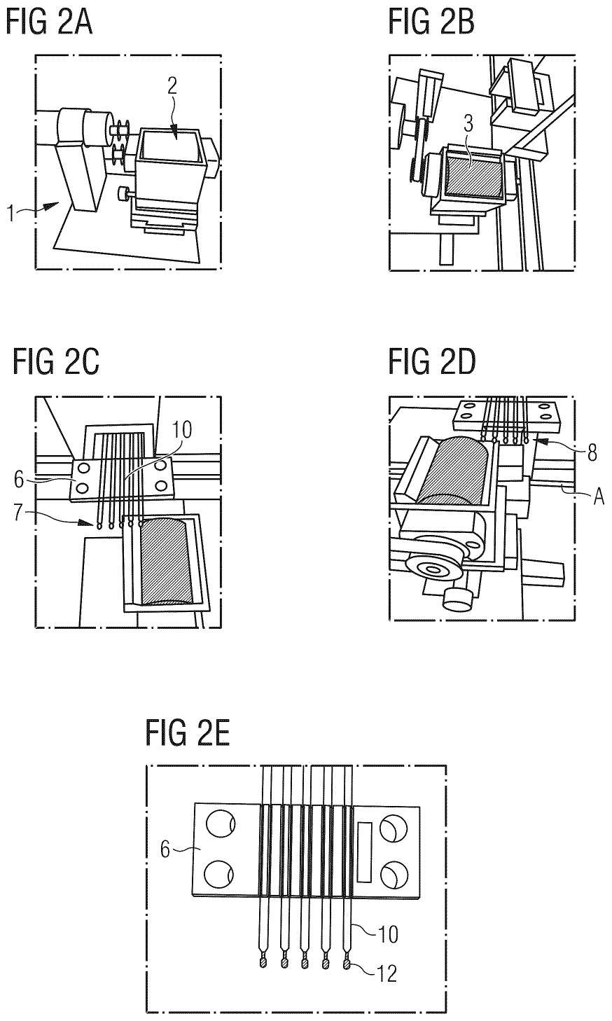

FIGS. 2a to 2e show method steps for applying a coating to at least one electronic component,

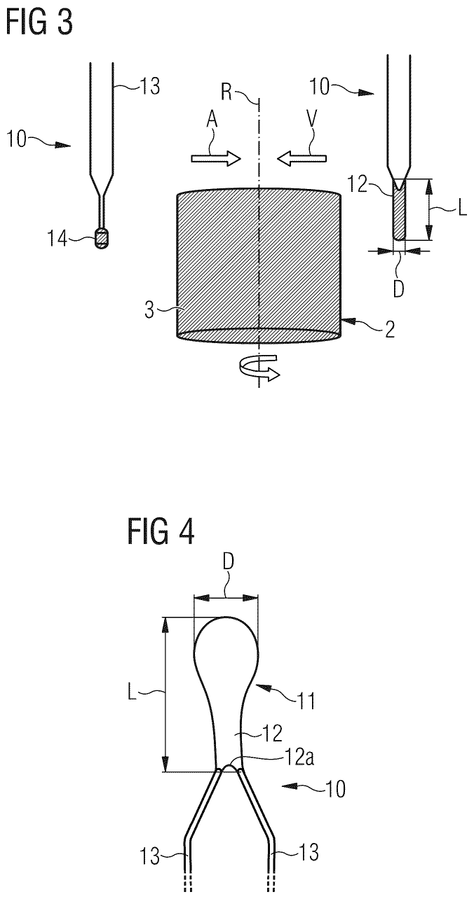

FIG. 3 schematically shows a method step for applying a coating to at least one electronic component,

FIG. 4 schematically shows a perspective view of a coated electronic component,

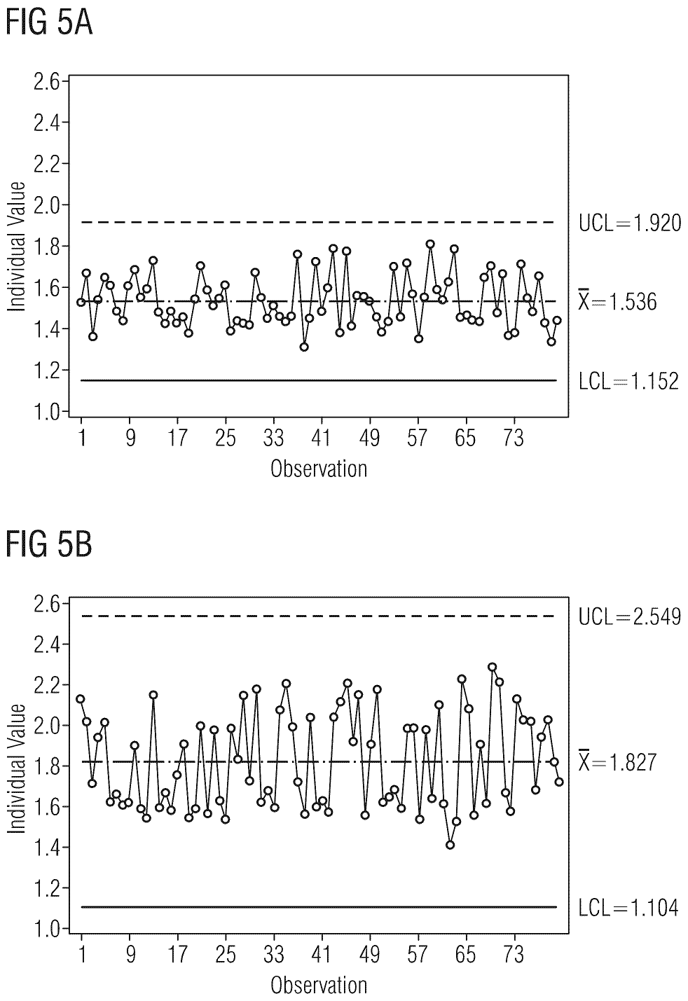

FIGS. 5a and 5b show diagrams illustrating a head diameter of a sensor arrangement coated by the method according to the invention and of a sensor arrangement coated by conventional technology.

In the figures, elements of the same structure and/or functionality may be referenced by the same reference numerals. It is to be understood that the embodiments shown in the figures are illustrative representations and are not necessarily drawn to scale.

FIGS. 1a and 1b show a coating arrangement 1. The coating arrangement 1 is adapted and arranged to apply a coating 12 onto an electronic component 10, in particular onto a part of the electronic component 10. The coating arrangement 1 is adapted to simultaneously coat a large number of electronic components 10.

The coating arrangement 1 comprises a coating roller 2. The coating roller 2 is rotatable around a rotation axis R. The coating roller 2 is unidirectionally rotatable. The coating roller 2 is prevented from being moveable in an axial direction.

The coating roller 2 comprises a cylinder. The coating roller 2 has a smooth outer (cylindrical) surface. A coating material 3 (see, for example FIGS. 2b to 2d) can be applied onto the smooth outer surface of the coating roller 2.

The coating material 3 is viscous. A viscosity of the coating material 3 is between 4000 cP and 10000 cp, for example. Preferably, the coating material 3 comprises a polymer. A coating material composition of weight solids may be between 53.4% and 57.4%. No mixing steps are necessary for the coating material 3. In other words, the coating material remains an emulsion throughout the process.

The coating arrangement 1 further comprises a motor 4. The motor 4 is adapted and arranged to drive (i.e. to rotate) the coating roller 2. The coating arrangement 1 further comprises a power source 5 for electrically connecting the motor 4.

The coating arrangement 1 further comprises a mounting element 6. The mounting element 6 is moveable. The mounting element 6 can be moved horizontally. The mounting element 6 is prevented from being rotated.

The mounting element 6 is horizontally moveable along a longitudinal axis A (FIG. 1b). The longitudinal axis A is perpendicular to the rotation axis R. The mounting element 6 is moveable along the longitudinal axis A from a start position 7 to an end position 8 (see FIGS. 2c and 2d). The mounting element 6 is unidirectionally moveable. In other words, a movement of the mounting element 6 in the opposite direction, i.e. from end position 8 to start position 7, is prevented.

The mounting element 6 is adapted and arranged to hold a plurality of electronic components 10. For this purpose, the mounting element 6 comprises a plurality of indentations (see FIG. 2e, for example) into which the electronic components 10 are partly inserted. The indentations extend perpendicular with respect to a main longitudinal axis of the mounting element 6. The opposite ends of the electronic components 10 protrude beyond side surfaces of the mounting element 6 as can be gathered from FIG. 2e, for example.

In the following, the functionality of the coating arrangement 1 is described in connection with FIGS. 2a to 2e and FIG. 3 which show method steps for applying a coating 12 to at least one electronic component 10.

At first (step A) of the method), the previously described a coating arrangement 1 is provided (FIG. 2a).

In a next step B), the coating material 3 is provided as can be gathered from FIG. 2b. The coating material 3 is provided on the smooth outer surface of the cylindrical coating roller 2. In particular, the outer surface of the coating roller 2 is completely wetted with the viscous coating material 3. The coating material 3 is homogeneously distributed on the coating roller 2. No bubbles are present in the coating material 3 on the surface of the coating roller 2 (FIGS. 2b to 2d).

As mentioned above, the coating material composition of weight solids may be between 53.4% and 57.4%. No mixing steps are necessary for the coating material 3. The coating material 3 remains an emulsion throughout the whole process. In a next step C), the electronic components 10 are mounted onto the mounting element 6. The mounting element 6 is arranged at a lateral distance from the coating roller 2, and thus, from the coating material 3, as can be gathered from FIG. 2c.

As described above, the mounting element 6 is horizontally/laterally moveable along longitudinal axis A. In this method step, the mounting element 6 and, thus, the respective electronic component 10, is in a fixed horizontal/lateral position, i.e. start position 7 (FIG. 2c: left of the coating roller 2).

In a next step D), the coating roller 2 is rotated around rotation axis R. Thereby, a certain thickness of the viscous coating material 3 is generated (see also FIG. 3).

The mounting element 6/the respective electronic components 10 is moved along the rotating coating roller 2 (i.e. along longitudinal axis A) from the start position 7 towards the end position 8 (FIGS. 2c and 2d). Thereby, the respective electronic component 10 comes into direct contact with the coating material 3. A direction of a viscous force V of the coating material 3 is opposite to the direction into which the electronic component is moved along longitudinal axis A (see FIG. 3), so that the electronic component 10 is covered partly with the viscous coating material 3. Only a defined length of the electronic component 10 (the part of the electronic component 10 which is to be coated) is immersed through the coating material 3 rolled continuously on the coating roller 2, which can be gathered from FIG. 3. At the end of the process, the mounting element 6 and, thus, the respective electronic component 10 is arranged at the end position 8 (FIG. 2d: right of the coating roller 2) and the respective electronic component 10 comprises a coating 12 (see FIGS. 2e and 3). The coating 12 comprises a length L and a diameter D (head diameter of coated electronic component 10), as can be seen from FIGS. 3 and 4.

FIG. 4 shows an example of a coated electronic component 10. The electronic component 10 may comprise a wire contacted electronic component. The electronic component 10 may comprise a sensor arrangement, which is designed to measure a temperature, e.g. a miniaturized NTC temperature sensor arrangement.

The electronic component 10 has a sensor element or a sensor chip 14 (see FIG. 3). The sensor element 14 is preferably an NTC thermistor chip. The electronic component 10 further comprises two contacting elements 13 for electrical contacting of the sensor element 14. The contacting elements 13 preferably comprise wires. The contacting elements 13 are electrically and mechanically connected to electrodes of the sensor element 14 (not explicitly shown).

The electronic component 10 further comprises a coating 12, i.e. the coating 12 achieved by the previously described method. The coating 12 completely encloses the sensor element 14. The coating 12 constitutes a head 11 of the electronic component 10 (sensor head). The head 11 comprises the sensor element 14 and at least a partial area of the contacting elements 13 as well as the coating 12, as can be seen in FIGS. 3 and 4. The coating 12 forms an outer shell of an upper part of the electronic component 10 and protects it from environmental influences.

An indentation 12a of the coating 12 occurs on an underside of the coating 12. The head 11 extends from an upper end of the electronic component 10 to an upper limitation of the indentation 12a (i.e. total length L of the coating 12/the head 11).

The head 11 comprises a diameter D, i.e. an extension perpendicular to the length L. A variation in the diameter D of the head 11 is small. The variation in the diameter D of the head 11 achieved by the previously described method is small (see FIG. 5A). In contrast thereto, the variation in the head diameter of electronic components coated by conventional coating methods is statistically significantly higher (see FIG. 5B). Thus, the method described above is a stable process.

All in all, by means of the previously described coating method, a variation in the sensor head diameter is statistically significantly lower as compared to conventional coating technology. In absolute terms, the diameter D is also smaller as compared to head diameters of conventional coated electronic components. Compact and cost effective electronic components with well-defined geometrical dimensions are thus provided by means of the roller coating method.

The invention is not limited to the embodiments by the description based thereon. Rather, the invention encompasses any new feature as well as any combination of features, which in particular includes any combination of features in the claims, even if this feature or combination itself is not explicitly stated in the claims or embodiments.

### Reference numerals

1 Coating arrangement
2 Coating roller
3 Coating material
4 Motor
5 Power source
6 Mounting element
7 Start position
8 End position
10 Electronic component
11 Head
12 Coating
12a Indentation
13 Contacting element
14 Sensor element
R Rotation axis
D Head diameter
L Coating Length
V Viscous Force
A Longitudinal axis

1-16. (canceled)

17. A method for applying a coating to at least one electronic component, the method comprising:
providing a coating arrangement that includes a coating roller, wherein the coating roller is rotatable around a rotation axis;
providing a coating material on the coating roller;
providing the at least one electronic component; and
moving the at least one electronic component along the coating roller to obtain a coating of at least a part of the electronic component.

18. The method according to claim 17, wherein moving the at least one electronic component along the coating roller includes moving the at least one electronic component along a longitudinal axis from a start position to an end position, wherein the longitudinal axis is perpendicular to the rotation axis.

19. The method according to claim 18, wherein a direction of a viscous force of the coating material is opposite to a direction in which the at least one electronic component is moved along the longitudinal axis.

20. The method according to claim 17, wherein moving the at least one electronic component along the coating roller includes bringing the at least one electronic component into direct contact with the coating material.

21. The method according to claim 17, wherein moving the at least one electronic component along the coating roller includes immersing a defined length of the at least one electronic component through the coating material.

22. The method according to claim 17, wherein a viscosity of the coating material is between 4000 centipoise (cP) and 10000 cP.

23. The method according to claim 17, wherein the coating material comprises a polymer.

24. The method according to claim 17, wherein a composition by weight of solids in the coating material is between 53.4% and 57.4%.

25. The method according to claim 17, wherein the at least one electronic component includes a plurality of electronic components, wherein each respective electronic component includes a sensor head, and wherein a variation in a diameter of the sensor head of each respective electronic component is smaller after coating as compared to a variation of the diameter of sensor heads of electronic components coated by conventional coating technology.

26. The method according to claim 17, wherein the at least one electronic component includes a negative temperature coefficient (NTC) temperature sensor.

27. The method according to claim 17, wherein the coating roller is rotated around a rotation axis such that a certain thickness of the coating material is generated.

28. The method according to claim 17, wherein the coating material remains an emulsion as the at least one electronic component is moved along the coating roller.

29. A coating arrangement for applying a coating to at least one electronic component, the coating arrangement comprising a coating roller which is rotatable around a rotation axis.

30. The coating arrangement according to claim 29, wherein the coating roller is configured to be wetted with a coating material.

31. The coating arrangement according to claim 30, wherein the coating material comprises a polymer.

32. The coating arrangement according to claim 29, further comprising a mounting element for holding the at least one electronic component.

33. The coating arrangement according to claim 32, wherein the mounting element is moveable along a longitudinal axis which is perpendicular to the rotation axis.

34. The coating arrangement according to claim 32, wherein the mounting element is configured to hold a plurality of electronic components.
